(19) United States
(12) Patent Application Publication
(10) Pub. No.: US 2023/0234848 A1
(43) Pub. Date: Jul. 27, 2023

(54) PROCESS TO PRODUCE LITHIUM COMPOUNDS

(71) Applicant: RECION TECHNOLOGIES, INC., Edmonton (CA)

(72) Inventors: Salman SAFARIMOHSENABAD, Edmonton (CA); Daniel S. ALESSI, Edmonton (CA)

(21) Appl. No.: 17/918,978

(22) PCT Filed: Apr. 16, 2021
(86) PCT No.: PCT/CA2021/050523

§ 371 Date: Oct. 14, 2022

Related U.S. Application Data
(60) Provisional application No. 63/012,763, filed on Apr. 20, 2020.

(51) Int. Cl. C01B 25/30; C01D 15/02; C01D 15/08; B01J 39/02; B01J 39/10; B01J 49/53; C22B 26/12; C22B 3/42; B01D 15/36; B01D 15/20; B01D 15/42; C25B 1/14; C25B 1/16

(52) U.S. Cl. CPC C01B 25/306; C01B 25/303; C01D 15/02; C01D 15/08; B01J 39/02; B01J 39/10; B01J 49/53; C22B 26/12; C22B 3/42; B01D 15/362; B01D 15/203; B01D 15/426; C25B 1/14; C25B 1/16; C01P 2006/80

(57) ABSTRACT

A method of producing lithium phosphate from a lithium source includes the step of (a) concentrating the lithium to produce a lithium concentrate, with an ion exchange sorbent, and (b) reacting the lithium concentrate with phosphate anions to produce lithium phosphate. The lithium phosphate may then be converted to lithium hydroxide or lithium 5 carbonate by reaction with calcium hydroxide or by electrolysis.

### CROSS-REFERENCE TO RELATED APPLICATION

This application claims the priority benefit of U.S. Provisional Patent Application No. 63/012,763, filed on Apr. 20, 2020, the entire contents of which are incorporated herein by reference, where permitted.

### THE FIELD OF THE INVENTION

The present invention relates generally to a process to produce a lithium (Li) product from a Li source solution, which product can be converted into LiOH or Li₂CO₃.

### BACKGROUND OF THE INVENTION

Traditionally, lithium products have been used in ceramic and glass products, greases and lubricants as thermal resistance modifiers, in aluminum production as a viscosity modifier, in synthetic rubbers to provide resistance to abrasion, in pharmaceuticals as catalyst during manufacturing, and in commercial air conditioning as a dehumidifier (Kesler et al., 2012). Because of growing demand for rechargeable lithium ion batteries (LIBs), lithium and its compounds have been among the most sought-after chemicals (Meshram et al., 2014; Swain, 2016). Battery grade Li₂CO₃ and LiOH are the two main lithium compounds which are currently used in LIBs; the former is conventionally produced through chemical precipitation and the latter can be generated by electrolysis of a lithium concentrate or by a conventional and less efficient method of dissolving lithium carbonate in caustic lime (Yuan et al., 2017).

Lithium is found in rocks and brines; the latter makes up more than 60% of global lithium resources (Xu et al., 2016). Lithium extraction from brines derived from salars is conventionally achieved by removal of undesirable ions such as magnesium and calcium, followed by concentration of the brine in solar evaporation ponds and chemical precipitation of lithium compounds from the concentrated brine. Most production plants that extract lithium from brine are located in South America, where climate favors water evaporation and operating cost is low; however, often more than 50% of the lithium is lost during these steps and the process has a significant environmental footprint and is a very lengthy process (Meshram et al., 2014).

To eliminate the evaporation requirement and improve purification and overall lithium recovery, several approaches have been tested to selectively extract lithium from brine, among which inorganic ion exchangers are among the most attractive candidates (Meshram et al., 2014; Xu, et al., 2016; Swain, 2016; Swain, 2017). Manganese based sorbents such as those with chemical formulas of H_{1.3}Mn_{1.7}O₄ and H_{1.6}Mn_{1.6}O₄ are promising ion exchangers because of their high Li uptake capacity and selectivity which stem from the smaller ionic radius and lower hydration energy of lithium ions compared to other cations (Xu et al., 2016; Liu et al., 2019b). Moreover, such sorbents can recover more than 90% of Li, even from low Li-bearing brines, which makes them applicable to a broader range of resources. However, ion exchange technologies have not progressed beyond laboratory scale experiments to become commercially viable. One of the major barriers in their commercialization is the chemical degradation of the sorbent due to the use of concentrated acid for concentrating extracted lithium. Use of dilute acid has been found to be effective in inhibiting the deterioration of ion exchangers (Liu et al., 2019a; Gao et al., 2019); however, to generate a final LiOH product, the extracted Li needs to be significantly concentrated and separated from other cations such as Na⁺, K⁺, Ca,²⁺ and Mg²⁺.

There remains a need in the art for a method of Li purification which may mitigate one or more of the disadvantages of the prior art.

### SUMMARY OF THE INVENTION

Generally, this invention relates to a method of producing lithium compounds from a lithium source, comprising the step of producing a lithium concentrates using an ion exchange sorbent, and producing lithium compounds from the lithium concentrate.

In one aspect, the invention may comprise a method of producing lithium phosphate from a lithium source, comprising the steps of:
(a) contacting the lithium source with an ion exchange sorbent to sorb lithium;
(b) producing a lithium concentrate, by desorbing the lithium from the sorbent by proton exchange using an acidic desorption fluid, either (i) at a steady-state pH which is low enough to desorb sufficient lithium to produce the lithium concentrate, but not so low as to degrade the sorbent, such as at an steady-state pH of between about 1.0 and about 2.5, or (ii) a concentration of acid and the sorbent such that the molar ratio between the initial H⁺ and final Li⁺ concentration in the desorption fluid is between about 0.5 and 8.0.

In some embodiments, the steady-state pH for the desorption step is preferably between 1.7 and 1.9 or the molar ratio between initial H⁺ and final Li⁺ concentrations is preferably between about 0.7 and 6.0, and more preferably between about 1.0 to about 2.0.

The lithium source may be any suitable source, such as petrobrines, brines derived from salars, acid leachates, and seawater. The ion exchange sorbent may comprise inorganic sorbents such as Mn-, Ti-, Sb- or Al-based sorbents. Suitable sorbents include, without limitation, H₁₋₂Mn₁₋₂O₃₋₄, H₂TiO₃, H₄Ti₅O₁₂, H₂SbO₃. The sorbent may be uncoated, and/or may be mixed with a binder, which may be organic or inorganic, or a mixture thereof.

In some embodiments, the lithium concentrate is polished to remove multivalent ions. In some embodiments, the polishing step comprises one or more of the following: increasing pH (such as by addition of caustic and/or sodium carbonate), ion exchange treatment, solvent extraction, or precipitation.

In some embodiments, following removal of multivalent ions in the polishing step, the polished Li concentrate is mixed with phosphate anions, from any suitable phosphate compound, to precipitate lithium phosphate, which has a significantly lower solubility as compared to other monovalent ion phosphate compounds. In some embodiments, the lithium concentrate should have at least 100 ppm of Li, preferably greater than about 1000 ppm, more preferably in the range of about 2000 to about 3000 ppm. It is preferred to have a concentration less than about 3000 ppm.

In some embodiments, during the Li phosphate precipitation step, the final pH of the Li concentrate and phosphate mixture is maintained at greater than 7.0, preferably at about 11.0 to about 12.5, and its temperature is kept between about 20° C. to about 90° C., preferably higher than 60° C., to accelerate the kinetics of precipitation.

The produced lithium phosphate may then be further processed to produce LiOH or Li₂CO₃, either by mixing the precipitate with Ca(OH)₂ or by electrolysis.

In some embodiments, electrolysis of the lithium phosphate is performed in an electrolysis unit having two or more compartments to produce LiOH from the precipitate.

For electrolysis purposes, lithium phosphate is dissolved in an acid such as HCl, H₂SO₄, or phosphoric acid, which then serves as anolyte or feed solution in a multi-compartment electrolysis setup, respectively. Such a setup allows efficient LiOH generation in the catholyte and acid regeneration in the anolyte. Phosphoric acid is a preferred acid since it is a polyprotic acid which can capture protons generated in anolyte and prevent their migration to the catholyte, lowering energy consumption to produce LiOH.

Optionally, after phosphate addition, the supernatant of the Li concentrate can be processed further in a chloralkali electrochemical setup to produce NaOH or KOH in the catholyte and phosphoric/sulfuric acid or chlorine gas in the anolyte, as the supernatant is rich in Na and K (more than 1 M) with significantly lower concentrations of Li (typically less than 200 ppm).

### DETAILED DESCRIPTION OF EMBODIMENTS OF THE INVENTION

In some embodiments, the present invention comprises a method of producing lithium phosphate from a lithium source, comprising the steps of:
(a) concentrating the lithium source with an ion exchange sorbent to produce a lithium concentrate; and
(b) reacting the lithium concentrate with phosphate anions to produce lithium phosphate.

The lithium phosphate may then be converted to lithium hydroxide or lithium carbonate by reaction with calcium hydroxide or by electrolysis.

Lithium concentrate is produced by ion exchange using a solid sorbent, from lithium sources such as petrobrines, salars, acid leachates, and seawater. The sorbent may comprise Mn, Ti, Al or Sb-based sorbents. Metal oxide lithium sorbents are well known in the art and are reviewed in Safari et al. (Safari et al., 2020), the entire contents of which are incorporated herein by reference.

As used herein, an “ion exchange sorbent” is a material which contains functional groups, where protons can be exchanged with cations. To extract lithium ions, the material also acts as an ionic sieve, allowing passage of lithium ions due to the small ionic radii of lithium ions. Larger metal ions are excluded from the pore space of the sorbent material, allowing for selective extraction of lithium. In some embodiments, the sorbent is uncoated.

Mn-based sorbents. In some embodiments, the ion exchange sorbent may be prepared by solid phase reaction between a manganese salt and a lithium salt. Suitable manganese salts include manganese acetate tetrahydrate, manganese nitrate, manganese dioxide, manganese carbonate, and manganese oxalate dihydrate. Suitable lithium salts include lithium nitrate, lithium acetate dihydrate, lithium carbonate, lithium hydroxide monohydrate, and lithium hydroxide anhydrous.

In addition to solid phase reactions, Mn-based sorbents, such as H_{1-1.6}Mn_{1.6-2}O₄, can be produced by a variety of methods such as hydrothermal, reflux, or a combination of methods. For example, to produce 1 mole of Li_{1.3}Mn_{1.7}O₄, 1.7 mole of manganese acetate tetrahydrate is mixed with 1.3 mole of lithium acetate dihydrate using a mortar and pestle or a planetary ball mill for a few minutes or until the reagents are homogenously mixed. The mixture is calcined in a well-ventilated furnace at heating rate of 1-20° C./min, preferably 10° C./min, and at calcination temperature of 400° C. to 500° C., preferably about 450° C., for 1 to 24 hours, followed by natural cooling to room temperature. In lieu of solid phase mixing and to improve reagents mixing, the starting reagents can be dissolved in water or another solvent and mixed for 5-30 min. Following calcination, the solution is then dried, for example, at 60° C. to 90° C. The final product is ground to produce fine-grained precursors for ion exchange materials.

Ti-based sorbents. Ti-based sorbents, H₂TiO₃ and H₄Ti₅O₁₂, can be produced by a variety of methods such as hydrothermal, sol-gel, solid phase reactions or a combination of such methods. For example, to produce 1 mole of precursor Li₂TiO₃, 1 mole of titanium dioxide (anatase) is mixed with 1 mole of lithium carbonate using a mortar and pestle or a planetary ball mill for a few minutes or until the reagents are homogenously mixed. The mixture is calcined in a well-ventilated furnace at heating rate of 1-20° C./min, preferably 10° C./min, and at a calcination temperature of 500° C. to 900° C., preferably 700° C., for 1 to 24 hours followed by natural cooling to room temperature (Chitrakar et al., 2014).

Sb-based sorbents. Sb-based sorbents, HSbO₃·nH₂O, can be produced by reflux, solid phase reaction or a mix of both. For example, to produce precursor LiSbO₃, LiOH solution is added to SbCl₅ at a Li:Sb molar ratio >1 and at 20-90° C. followed by stirring for 1-48 hours. The resulting precipitate is centrifuged or filtered and washed with water followed by calcination at 700-1100° C., preferably 900° C., at a heating rate of 1-20° C./min for 1-24 hours followed by natural cooling to room temperature (Chitrakar and Abe, 1983).

Binder. Since the produced sorbent precursors may typically be smaller than about 2 μm, using a binder to agglomerate the particles is preferred for their use in a commercial operation. Any suitable inorganic or organic binder, or a mixture, may be used. For example, a sorbent precursor (such as Li_{1.3}Mn_{1.7}O₄ ) can be added to an inorganic colloidal suspension. The resulting slurry is dried at 60° C. overnight and calcined at 60-500° C. for 1-10 hours. The resulting powder is ground to fine particles (<1 mm) by a ball-mill or a mortar and pestle set. Alternatively, to produce larger <5 mm particles, the slurry can be processed by a pelletizer, extruder or granulator, followed by drying and calcination as outlined above.

Sorbent Activation and Li extraction from brines. The precursor sorbent material is activated by exchanging Li in the precursor material with protons, by mixing the precursor with acid for a sufficient length of time, which may range from 5 min to 7 days. Any suitable acid may be used for activation, including a wide range of inorganic or organic acids, such as hydrochloric, sulfuric, nitric, phosphoric, oxalic, or acetic acid.

The activated sorbent is then mixed with the lithium source such as brine to extract the lithium, preferably at temperatures 20° C. or higher and at a pH greater than about 4, more preferably at a pH between about 6 to about 8, for sufficient time, for example 1 min to 24 hours. During extraction, Li ions in the brine replace protons in the sorbent. The Li-loaded sorbent is then separated from the brine by any suitable method, such as gravimetrically and/or by filtration, followed by washing with water.

Li Desorption. Li ions may be then be desorbed from the washed Li sorbent by mixing with an acid, such as sulfuric acid or phosphoric acid, which replaces the Li ions with protons. A preferred acid for Mn- and Ti-based sorbents is phosphoric acid.

Phosphoric acid supplies phosphate ions to the Li concentrate, allowing the precipitation of multivalent ions from the concentrate under acidic or neutral conditions prior to Li₃PO₄ separation. In the case of Ti-based sorbents, the desorption fluid pH is preferably between 1.0 and 2.5, more preferably between 1.7 and 1.9, in order to desorb and concentrate Li without degrading the sorbent. A polyprotic acid such as phosphoric acid may be preferred as it acts as a buffering agent which can maintain the pH more efficiently than other acids and is less detrimental to both Mn- and Ti-based sorbents.

In some embodiments, the sorbent is dispersed in water, and acid is added. The addition of a concentrated acid may result in a very low initial pH. The pH will increase as Li is desorbed, and eventually will reach a steady-state pH as the desorption process nears completion. In some embodiments, additional acid may be added to lower the pH again, if necessary to continue the desorption process. The steady-state pH is the pH measured when Li desorption is complete or substantially complete.

In some embodiments, such as in a process where accurate pH measurement during the desorption step is not convenient, such as in an absorption column, it may be preferred to choose concentrations of acid and sorbent such that the molar ratio between the initial H⁺ and final Li⁺ concentration is between about 0.5 to about 8.0, preferably between about 0.7 and 6.0, and more preferably between about 1.0 to about 2.0. In this case, the proton concentration in the volume of desorption fluid is calculated and compared to the expected or actual lithium concentration once desorption is complete.

### Polishing

The lithium concentrate may be polished to remove multivalent ions. The polishing step comprises one or more of the following: increasing its pH (such as by addition of caustic (NaOH) and/or sodium carbonate), ion exchange treatment, solvent extraction, or precipitation. In some embodiments, NaOH is added to the lithium concentrate to raise its pH to greater than about 10, which results in the precipitation of the multivalent ions, which can be removed by filtration. The lithium concentrate may then be further polished using an ion exchanger or chelating resin, such as AmberLite™ IRC747 or other known multivalent ion sorbent.

### Conversion to Phosphate

After the polishing step where multivalent ions are removed, the polished Li concentrate is mixed with phosphate anions to precipitate lithium phosphate, which has a significantly lower solubility as compared to other monovalent ion phosphate compounds. The source of phosphate anions may comprise phosphoric acid, potassium phosphate monobasic, potassium phosphate dibasic, potassium phosphate tribasic, sodium phosphate monobasic, sodium phosphate dibasic, sodium phosphate tribasic, ammonium phosphate monobasic, ammonium phosphate dibasic, ammonium phosphate tribasic, or any other suitable phosphate compound.

In some embodiments, the lithium concentrate should have at least 100 ppm of Li, preferably greater than about 1000 ppm, more preferably in the range of about 2000 to about 3000 ppm. It is preferred to have a concentration less than about 3000 ppm. Lithium concentrations greater than about 3000 ppm are possible, but are not preferred, since more phosphate reagents are required, which could lead to co-precipitation of sodium or potassium phosphate.

In some embodiments, the final pH of the Li concentrate and phosphate mixture is maintained at greater than 7.0, preferably at about 11.0 to about 12.5, and its temperature is kept between about 20° C. to about 90° C., preferably higher than 60° C., to accelerate the kinetics of precipitation. The resulting lithium phosphate precipitate can be collected by centrifugation and/or filtration and washed with a small volume of fresh water to remove residual undesirable ions such as Na⁺, K⁺, Ca²⁺, Mg²⁺, and Sr²⁺, while minimizing lithium phosphate dissolution.

Optionally, after precipitation of lithium phosphate, the supernatant can be processed further in a chloralkali electrochemical setup to produce NaOH or KOH in the catholyte and phosphoric/sulfuric acid or chlorine gas in the anolyte, as the supernatant is rich in Na and K (more than 1 M) with significantly lower concentrations of Li (typically less than 200 ppm).

### Electrolysis or Precipitation

The produced lithium phosphate may then be further processed to produce LiOH or Li₂CO₃, either by mixing the precipitate with Ca(OH)₂ or by electrolysis.

In some embodiments, electrolysis of the lithium phosphate is performed in an electrolysis unit having two or more compartments to produce LiOH from the precipitate. For electrolysis purposes, lithium phosphate is dissolved in an acid such as HCl, H₂SO₄, or phosphoric acid, which then serves as anolyte or feed solution in a multi-compartment electrolysis setup, respectively. Such a setup allows efficient LiOH generation in the catholyte and acid regeneration in the anolyte. Phosphoric acid is a preferred acid since it is a polyprotic acid which can capture protons generated in anolyte and prevent their migration to the catholyte, lowering energy consumption to produce LiOH.

In some embodiments, conversion to LiOH·H₂O by electrolysis consumes energy less than 6, preferably less than 5, and more preferably about 4 kwh/kg of LiOH·H₂O. Without restriction to a theory, such low energy consumption may be the result of the buffering capacity of phosphate anions in the anolyte as evidenced by the absence of pH change in the anolyte.

Examples—the following examples are provided to exemplify the described invention, and not to limit the claimed invention in any manner.

### Example 1—Titanium Ion Exchanger

To produce an ion exchange sorbent, 1 mole of titanium dioxide nanopowder (anatase) was mixed with 1 mole of lithium carbonate using a mortar and pestle for a few minutes. The mixture was calcined in a furnace at heating rate of 10° C./min and at calcination temperature of 700° C. for 4 hours followed by natural cooling to room temperature. The precursor, Li₂TiO₃, was mixed with 0.3 M phosphoric and the initial pH reached 1.9. After 22 hours of mixing at room temperature, the pH reached 2.5 and the sorbent was separated by centrifugation and was washed with water.

The protonated sorbent was mixed with buffered synthetic brine containing 357 ppm Li, 76 ppm B, 28100 ppm Na, 2270 ppm Mg, 6200 ppm K, 131 ppm Ca, and 6100 ppm HCO₃⁻ having an initial pH of 6.6 for 18 hours at room temperature. At the end of the extraction, the pH remained at 6.6 and the sorbent was separated by centrifugation and washed with water to remove the residual brine. The sorbent was dried, weighed and mixed with 0.45 M phosphoric acid at room temperature for 22 hours. The initial pH of the mixture was 1.9 and at the end of the extraction the sorbent was separated from the acid by centrifugation and the supernatant was analyzed for cations concentrations. The Li concentrate contained 1714 ppm Li, 5 ppm B, 640 ppm Na, 76 ppm Mg, 92 ppm K, 44 ppm Ca, and 9 ppm Ti. The results indicated 80% Li recovery from the original brine with <0.02% loss of the sorbent.

To produce an ion exchanger with an inorganic/organic mixture binder, 1 mole of titanium dioxide nanopowder (anatase) was mixed with 1 mole of lithium carbonate using a mortar and pestle for a few minutes. The mixture was calcined in a furnace at heating rate of 10° C./min and at a calcination temperature of 700° C. for 4 hours followed by natural cooling to room temperature. Li₂TiO₃ was mixed with colloidal silica, polyvinylpyrrolidone (PVP), and water for one hour at room temperature. The suspension was dried at 60° C. overnight. The bound precursor was mixed with 0.2 M sulfuric acid at room temperature for 14 hours. The final pH reached 1.5 and the sorbent was separated by filtration and washed with water. The protonated sorbent was used in a packed bed system, and a brine with an initial Li concentration of 80 ppm and an initial pH of 8 was circulated in the column at 10 mL min⁻¹ for 22 hours. Following, deionized water was circulated in the column to remove the residual brine. To desorb Li, 0.05 M H₂SO₄ was circulated in the sorbent for 45 min, after which the pH was 1.5.

### Example 2—Manganese Ion Exchanger

To produce an ion exchanger, manganese and lithium salts were ground together using a mortar and pestle. The mixture was heated at 10° C./min to 400° C. and calcined for 4 hours followed by natural cooling to room temperature. 30 g of precursor Li_{1.3}Mn_{1.7}O₄ was mixed with 30 mL of 30% colloidal silica for an hour followed by drying at 60° C. The dried mixture was heated at 10° C./min to 400° C. and calcined for 4 hours followed by natural cooling to room temperature. The bound sorbent was ground and sieved to <1 mm. 2 g of the sieved sorbent was dispersed in 200 mL of 0.6 M HCl. The ion exchange media was separated from acid by filtration (10 μm pore size filter) followed by a water wash. 1400 mg of protonated sorbent was added to a synthetic brine with an inorganic profile of 603 ppm Li, 127 ppm B, 50000 ppm Na, 4150 ppm Mg, 9470 ppm K, 106 ppm Ca, and 6100 ppm HCO₃⁻ having an initial pH of 6.6. After 22 hours of Li extraction at room temperature, the ion exchange (IX) media was separated from brine by filtration (10 μm pore size filter) followed by a water wash. The sorbent was dried at 60° C. overnight, and 200 mg of Li-loaded sorbent was mixed with 2.5 M phosphoric acid at room temperature for one hour. The sorbent was separated from the acid by centrifugation and the supernatant was analyzed by inductively coupled plasma (ICP) analysis. The Li concentrate contained 1683 ppm Li, 20 ppm B, 593 ppm Na, 184 ppm Mg, 313 ppm K, 92 ppm Ca, and 24 ppm Mn.

To produce an ion exchanger with inorganic binder, manganese and lithium salts were ground together using a mortar and pestle followed by heating to 400° C. at 10° C./min in a tube furnace for 16 hours before natural cooling to room temperature. To bind the particles (Li_{1.3}Mn_{1.7}O₄) and avoid mechanical loss of sorbent during Li (de)sorption, the resulting precursor was granulated with 30% colloidal silica to <2 mm particles. The sorbent was then used in a packed bed setup.

To produce an ion exchanger with organic binder, manganese and lithium salts were ground together using a mortar and pestle followed by heating at 400° C. at 10° C./min in a tube furnace and maintained at 400° C. for 16 hours before natural cooling to room temperature. To bind the particles (Li_{1.3}Mn_{1.7}O₄) and avoid mechanical loss of sorbent during Li (de)sorption, the resulting precursor was mixed with polyvinyl chloride (PVC) and N-Methyl-2-pyrrolidone for an hour followed by drying at 100° C. The resulting composite was broken into <2 mm particles and used in a filtration setup.

### Example 3—Production of Lithium Concentrate from a Synthetic Brine

A synthetic brine with an inorganic profile of 161 ppm Li, 412 ppm B, 50000 ppm Na, 3840 ppm Mg, 8730 ppm K, 25600 ppm Ca, and 915 ppm Sr, and having an initial pH of 7, was used for Li extraction. 1.4 mL of 1 M NaOH was added to 100 mL of the brine to raise the pH to 8 followed by heating of the brine to 70° C. 700 mg of Mn-based ion exchange (IX) media was added and mixed with the brine for an hour. The IX media was then separated by filtration (10 μm filter). After washing and drying at 60° C., the IX media was mixed with 5 mL of 0.5 M H₂SO₄ (pH 0.3) at room temperature for an hour followed by filtration. The produced Li concentrate had 1572 ppm Li, 46 ppm B, 460 ppm Na, 95 ppm Mg, 77 ppm K, 442 ppm Ca, and 31 ppm Sr. The concentrate pH was determined to be 1.3 which was raised to 12.3 by adding NaOH followed by centrifugation to separate the precipitate. The polished Li concentrate was then mixed with Amberlite™ IRC747 to remove remaining multivalent ions. The treated Li concentrate was mixed with 3 M potassium phosphate tribasic at 70° C. Lithium phosphate precipitate started to appear as a white powder after several minutes. The precipitate was washed with deionized water three times to remove the residual undesirable ions. The final precipitate was dissolved in a concentrated acid and its composition was determined to be 167140 ppm Li, 228 ppm B, 10140 ppm Na, 30 ppm Mg, 2662 ppm K, 8708 ppm Ca, and 2045 ppm Sr. By reducing the acid volume, a Li concentrate which has >30000 ppm Li can be prepared, while keeping other contaminants below about 2000 ppm.

A synthetic brine with an inorganic profile of 157 ppm Li, 356 ppm B, 50000 ppm Na, 3227 ppm Mg, 2662 ppm K, 25815 ppm Ca, 792 ppm Sr with an initial pH of 7 was used for Li extraction. 1 M NaOH was added to 100 mL of the brine to adjust the pH to 8 followed by heating the brine to 70° C. 1000 mg of Mn-based ion exchange (IX) media was added and mixed with the brine for an hour. The IX media was then separated by filtration (10 μm filter). After washing and drying at 60° C., the IX media was mixed with 5 mL of 0.5 M H₂SO₄ at room temperature for an hour followed by filtration.

The produced Li concentrate had 2077 ppm Li, 41 ppm B, 200 ppm Na, 125 ppm Mg, 72 ppm K, 657 ppm Ca, and 66 ppm Sr. The concentrate pH was determined to be 1.4, which was then raised to 11.9 by adding KOH followed by centrifugation to separate the precipitate. The polished Li concentrate was then mixed with Amberlite™ IRC747 to remove remaining multivalent ions.

The treated Li concentrate was mixed with 3 M potassium phosphate tribasic at 70° C. Lithium phosphate precipitate started to appear as a white powder after several minutes. The precipitate was washed with deionized water three times to remove the residual undesirable ions. The final precipitate was dissolved in a concentrated acid and its composite was determined to be 171787 ppm Li, 262 ppm B, 2252 ppm Na, 54 ppm Mg, 11648 ppm K, 5753 ppm Ca, and 1972 ppm Sr. By adjusting the acid volume, a Li concentrate can be prepared in which Li is >30000 ppm while other contaminants are <2000 ppm.

A synthetic brine with an inorganic profile of 147 ppm Li, 401 ppm B, 50000 ppm Na, 3583 ppm Mg, 8207 ppm K, 25549 ppm Ca, 871 ppm Sr with an initial pH of 7 was used for Li extraction. 1 M NaOH was added to 100 mL of the brine to adjust the pH to 7.7 followed by heating the brine to 70° C. 700 mg of Mn-based IX media was added and mixed with the brine for an hour. The IX media was then separated by filtration (10 μm filter). After washing and drying at 60° C., the IX media was mixed with 5 mL of 0.5 M H2SO4 at room temperature for an hour followed by filtration. The produced Li concentrate had 1521 ppm Li, 30 ppm B, 141 ppm Na, 89 ppm Mg, 35 ppm K, 412 ppm Ca, and 23 ppm Sr. The concentrate pH was determined to be 1.1 which was raised to 12.2 by adding KOH followed by centrifugation to separate the precipitate. The polished Li concentrate was then mixed with Amberlite™ IRC747 to remove remaining multivalent ions. The treated Li concentrate was mixed with 3 M potassium phosphate tribasic at 70° C. for 1 hour. A lithium phosphate precipitate starts to appear as a white powder after several minutes. The precipitate was washed with deionized water three times to remove the residual undesirable ions. The final precipitate was dissolved in a concentrated acid and its composition was determined to be 209670 ppm Li, 160 ppm B, 2622 ppm Na, 28 ppm Mg, 12398 ppm K, 4530 ppm Ca, and 667 ppm Sr. By adjusting the acid volume, a Li concentrate in which Li is >30000 ppm while other contaminants are <2000 ppm may be prepared.

### Example 4—LiOH Generation

176 mg of lithium phosphate precipitate having a composition of 119645 ppm Li, 215 ppm B, 781 ppm Na, 86 ppm Mg, 842 ppm K, 546 ppm Ca, and 102 ppm Sr was dissolved in 10.5 mL of 0.5 M H2504. The resulting solution had 2003 ppm Li, 3 ppm B, 48 ppm Na, below detection limit (BDL) Mg, 5 ppm K, 13 ppm Ca, and 1 ppm Sr. The solution served as the anolyte in a two-compartment electrolysis unit where a 42 ppm LiOH solution served as the catholyte separated from the anolyte by a monovalent cation selective membrane. Both electrolytes were circulated at 80 mL min⁻¹ in the electrolyzer and 20 V potential was applied to IrO-coated titanium electrode as the anode and stainless steel electrode as the cathode with an exposed surface area of 10 cm². After three hours, the Li concentration in the anolyte decreased to 589 ppm while the Li concentration in the catholyte increased to 1445 ppm as a result of Li migration from the anolyte to the catholyte. The final LiOH product has the following chemistry: 1445 ppm Li, BDL B, 31 ppm Na, BDL Mg, 2 ppm K, 1 ppm Ca, BDL Mn, and BDL Sr.

Lithium phosphate was dissolved in 17.5 mL of sulfuric acid. The resulting solution had pH of 2.5, 10128 ppm Li, 568 ppm Na, and below detection limit (BDL) Mg, K, Ca, and Sr. The solution served as the feed in a three-compartment electrolysis unit where a 4580 ppm LiOH solution served as the catholyte separated from the feed by a cation selective membrane. A dilute sulfuric acid was used as the anolyte separated from the feed by an anion selective membrane. All three electrolytes were circulated at 80 mL min⁻¹ in the electrolyzer and 3.5 V potential was applied to IrO-coated titanium electrode as the anode and stainless steel electrode as the cathode with an exposed surface area of 10 cm². After one hour, the Li concentration in the catholyte increased to 5467 ppm while the power consumption was calculated to be 4 kWh per kg of LiOH·H₂O.

### Exemplary Aspects

In view of the description, certain more particularly described aspects of the invention are presented below. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A method of producing lithium concentrate from a lithium source, comprising the steps of:
(a) contacting the lithium source with an ion exchange sorbent to sorb lithium;
(b) producing a lithium concentrate, by desorbing the lithium from the sorbent by proton exchange using an acidic desorption fluid, either (i) at a steady-state pH which is low enough to desorb sufficient lithium to produce the lithium concentrate, but not so low as to degrade the sorbent, or (ii) a concentration of acid and sorbent such that the molar ratio between the initial H+ and final Li+ concentration in the desorption fluid is between about 0.5 and 8.0.

Aspect 2: The method of aspect 1, wherein the steady-state pH of the desorption step is between about 1.0 and about 2.5.

Aspect 3. The method of aspect 1 or 2, wherein the steady-state pH of the desorption step is between about 1.7 and about 1.9, or the concentration of acid and sorbent is such that the molar ratio between the initial H+ and final Li+ concentration is between about 1.0 to about 2.0.

Aspect 4. The method of aspect 1, 2, or 3, wherein the sorbent is (a) uncoated, and/or (b) mixed with an organic or inorganic binder, or a combination of an organic and inorganic binder.

Aspect 5. The method of any one of aspects 1 to 4 wherein the acidic desorption fluid used in the desorption step comprises sulfuric acid, hydrochloric acid or phosphoric acid.

Aspect 6. The method of any one of aspects 1 to 5 wherein the lithium source is a brine solution having a Li concentration between about 1 to about 10,000 ppm.

Aspect 7. The method of any one of aspects 1 to 6 wherein the produced lithium concentrate is polished to remove multivalent ions and further concentrated to a final Li concentration greater than about 10,000 ppm, and preferably greater than about 20,000 ppm.

Aspect 8. The method of any one of aspects 1 to 7, comprising the further step of reacting the lithium concentrate with phosphate anions to produce lithium phosphate.

Aspect 9. The method of claim 8 wherein the phosphate anions comprise one or more of phosphoric acid, potassium phosphate monobasic, potassium phosphate dibasic, potassium phosphate tribasic, sodium phosphate monobasic, sodium phosphate dibasic, or sodium phosphate tribasic, ammonium phosphate monobasic, ammonium phosphate dibasic, or ammonium phosphate tribasic.

Aspect 10. The method of aspect 8 or 9, comprising the further step of converting the lithium phosphate to lithium hydroxide or lithium carbonate, by reaction with calcium hydroxide or by electrolysis.

Aspect 11. The method of aspect 8 or 9 wherein the lithium concentrate has at least 100 ppm of Li but not greater than about 3000 ppm, when reacting with phosphate anions.

Aspect 12. The method of aspect 11 wherein the lithium concentrate has a Li concentration greater than about 1000 ppm, more preferably in the range of about 2000 to about 3000 ppm.

Aspect 13. The method of aspect 5 wherein the acid used in the desorption step comprises phosphoric acid.

Aspect 14. The method of aspect 10 wherein converting the lithium phosphate to lithium hydroxide comprises dissolving the lithium phosphate is dissolved in a mineral acid such as HCl, H₂SO₄, or H₃PO₄, and then using the mineral acid with the dissolved lithium phosphate as an anolyte or feed solution in a multi-compartment electrolysis method.

Aspect 15. The method of any one of aspects 1 to 14 wherein a Ti-based sorbent is used as the ion exchange sorbent, and the desorption step is in a desorption fluid having a steady-state pH between about 1.7 and about 1.9.

Aspect 16. The method of aspect 15 wherein the Ti-based sorbent is first added to water and the pH of the mixture is lowered by adding an inorganic or organic acid, such as phosphoric, sulfuric, hydrochloric, or citric acid to the desorption fluid.

Aspect 17. The method of aspect 16 wherein the acid is a polyprotic acid which acts as a buffering agent, such as phosphoric acid or citric acid.

Aspect 18. The method of any one of aspects 1 to 14, wherein a Mn-based sorbent is used as the ion exchange sorbent, and the desorption step is in a desorption fluid having a concentration of acid and sorbent such that the molar ratio between the initial H⁺ and final Li⁺ concentration is between about 0.5 and 8.0, preferably between about 0.7 and 6.0, and more preferably between about 1.0 to about 2.0.

Aspect 19. The method of aspect 18 wherein the Mn-based sorbent has the formula H₁₋₂Mn₁₋₂O₃₋₄

Aspect 20. The method of aspect 10 or 14, wherein conversion of the lithium phosphate to LiOH·H₂O by electrolysis is performed in a multi-compartment electrolysis unit, wherein the lithium phosphate is dissolved in an acid which then serves as anolyte solution, and LiOH is generated in the catholyte.

Aspect 21. The method of any aspect comprising an electrolysis step to produce LiOH, wherein the electrolysis step consumes energy at less than 6.0, preferably less than 5.0, and more preferably about 4.0 kwh/kg of produced LiOH·H₂O.

Definitions. Any term or expression not expressly defined herein shall have its commonly accepted definition understood by a person skilled in the art.

### Interpretation

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

References—the following references are indicative of the level of skill of a skilled artisan. Each is incorporated herein by reference in its entirety, where permitted, for all purposes.

Chitrakar, R., Abe, M. (1988) Synthetic inorganic ion exchange materials XLVII. Preparation of a new crystalline antimonic acid HSb₃·0.12H₂O, Mat. Res. Bull., 23: 1231-1240

Chitrakar, R., Makita, Y., Ooi, K., Sonoda, A. (2014) Lithium recovery from salt lake brine by H₂TiO₃, Dalton Trans., 43: 8933-8939.

Gao, A., Hou, X., Sun, Z., Li, S., Li, H. (2019) Lithium-desorption mechanism in LiMn₂O₄, Li_{1.33}Mn_{1.67}O4, and Li_{1.6}Mn_{1.6}O₄ according to precisely controlled acid treatment and density functional theory calculations, J. Mater. Chem. A, 7: 20878-20890.

Hitchon, B., Bachu, S., Underschultz, J. R., Yuan, L. P. (1995) Industrial mineral potential of Alberta formation waters, Alberta Geological Survey: Alberta Research Council, Bulletin No. 62.

Kesler, S. E., Gruber, P. W., Medina, P. A., Keoleian, G. A., Everson, M. P., Wallington, T. J. (2012) Global lithium resources: Relative importance of pegmatite, brine and other deposits, Ore Geol. Rev., 48: 55-69.

Liu, D., Sun, S., Yu, J. (2019a) Li₄Mn₅O₁₂ desorption process with acetic acid and Mn dissolution mechanism, Journal of Chemical Engineering of Japan, 52: 274-279.

Liu, G.; Zhao, Z.; Ghahreman, A. (2019b) Novel approaches for lithium extraction from salt-lake brines: A review, Hydrometallurgy, 187: 81-100.

Meshram, P., Pandey, B. D., Mankhand, T. R. (2014) Extraction of lithium from primary and secondary sources by pre-treatment, leaching and separation: a comprehensive review, Hydrometallurgy, 150: 192-208.

Safari, S., Lottermoser, B. G., Alessi, D. S. (2020) “Metal oxide sorbents for the sustainable recovery of lithium from unconventional resources”. Applied Materials Today, 19, 100638.

Swain, B. (2016) Separation and purification of lithium by solvent extraction and supported liquid membrane, analysis of their mechanism: a review, J. Chem. Technol. Biotechnol., 91: 2549-2562.

Swain, B. (2017) Recovery and recycling of lithium: a review, Separ. Purif Technol., 172: 388-403.

Turan, A. Z., Baloglu, H., Unverena, E., Bulutcu, A. N. (2016) The behaviour of Nafion® 424 membrane in the electrochemical production of lithium hydroxide, J. Chem. Technol. Biotechnol., 91: 2529-2538.

Xu, X., Chen, Y., Wana, P., Gasem, K., Wanga, K., He, T., Adidharma, H., Fan, M. (2016) Extraction of lithium with functionalized lithium ion-sieves, Prog. Mater. Sci., 84: 276-313.

Yuan, J., Yin, H., Ji, Z., Deng, H. (2014) Effective recycling performance of Li+extraction from spinel-type LiMn2O4 with persulfate, Ind. Eng. Chem. Res., 53: 9889-9896.

KR20120015659A Manufacturing Method of lithium by electrolysis of lithium phosphate aqueous solution. (2012)

U.S. Pat. No. 8,936,711 B2, Method of extracting lithium with high purity from lithium bearing solution by electrolysis (2017)

Chon, U., Lee, I. C., Kim, K. Y., Han, G., Song, C. H., Jung, S. R. (2017) Method for manufacturing lithium hydroxide and method using same for manufacturing lithium carbonate, U.S. Pat. No. 9,598,291B2.

Guo, X., Cao, X., Huang, G., Tian, Q., Sun, H., (2018) Recovery of lithium from the effluent obtained in the process of spent lithium-ion batteries recycling, Korean J. Met. Mater., 56, 755-762.

Xiao, C., Zeng, L. (2018) Thermodynamic study on recovery of lithium using phosphate precipitation method, Hydrometallurgy, 178, 283-286.

1. A method of producing lithium concentrate from a lithium source, comprising the steps of:
(a) contacting the lithium source with an ion exchange sorbent to sorb lithium;
(b) producing a lithium concentrate, by desorbing the lithium from the sorbent by proton exchange using an acidic desorption fluid, either (i) at a steady-state pH which is low enough to desorb sufficient lithium to produce the lithium concentrate, but not so low as to degrade the sorbent, or (ii) a concentration of acid and the sorbent such that the molar ratio between the initial H⁺ and final Li⁺ concentration in the desorption fluid is between about 0.5 and 8.0.

2. The method of claim 1, wherein the steady-state pH of the desorption step is between about 1.0 and about 2.5.

3. The method of claim 1, wherein the steady-state pH of the desorption step is between about 1.7 and about 1.9, or the concentration of acid and sorbent is such that the molar ratio between the initial H+ and final Li+ concentration is between about 1.0 to about 2.0.

4. The method of claim 1, wherein the sorbent is:
(a) uncoated, and/or
(b) mixed with an organic or inorganic binder, or a combination of an organic and inorganic binder.

5. The method of claim 1 wherein the acidic desorption fluid used in the desorption step comprises sulfuric acid, hydrochloric acid or phosphoric acid.

6. The method of claim 1 wherein the lithium source is a brine solution having a Li concentration between about 1 to about 10,000 ppm.

7. The method of claim 1 wherein the produced lithium concentrate is polished to remove multivalent ions and further concentrated to a final Li concentration greater than about 10,000 ppm.

8. The method of claim 1, comprising the further step of reacting the lithium concentrate with phosphate anions to produce lithium phosphate.

9. The method of claim 8 wherein the phosphate anions comprise one or more of phosphoric acid, potassium phosphate monobasic, potassium phosphate dibasic, potassium phosphate tribasic, sodium phosphate monobasic, sodium phosphate dibasic, or sodium phosphate tribasic, ammonium phosphate monobasic, ammonium phosphate dibasic, or ammonium phosphate tribasic.

10. The method of any one of claim 8 or 9, comprising the further step of converting the lithium phosphate to lithium hydroxide or lithium carbonate, by reaction with calcium hydroxide or by electrolysis.

11. The method of claim 8 or 9 wherein the lithium concentrate has at least 100 ppm of Li but not greater than about 3000 ppm, when reacting with phosphate anions.

12. The method of claim 11 wherein the lithium concentrate has a Li concentration greater than about 1000 ppm.

13. The method of claim 5 wherein the acidic desorption fluid used in the desorption step comprises phosphoric acid.

14. The method of claim 10 wherein converting the lithium phosphate to lithium hydroxide comprises dissolving the lithium phosphate in a mineral acid such as HCl, H₂SO₄, or H₃PO₄, and then using the mineral acid with the dissolved lithium phosphate as an anolyte or feed solution in a multi-compartment electrolysis method.

15. The method of claim 1 to Li wherein a Ti-based sorbent is used as the ion exchange sorbent, and the acidic desorption fluid used in the desorption step has a steady-state pH between about 1.7 and about 1.9.

16. The method of claim 15 wherein the Ti-based sorbent is first added to water and the pH of the mixture is lowered by adding an inorganic or organic acid, such as phosphoric, sulfuric, hydrochloric, or citric acid to the desorption fluid.

17. The method of claim 16 wherein the acid is a polyprotic acid which acts as a buffering agent, such as phosphoric acid or citric acid.

18. The method of claim 1, wherein a Mn-based sorbent is used as the ion exchange sorbent, and the desorption step is in a desorption fluid having a concentration of acid and sorbent such that the molar ratio between the initial H⁺ and final Li⁺ concentration is between about 0.5 and 8.0, preferably between about 0.7 and 6.0, and more preferably between about 1.0 to about 2.0.

19. The method of claim 18 wherein the Mn-based sorbent has the formula H₁₋₂Mn₁₋₂O₃₋₄.

20. The method of claim 10 or 14, wherein conversion of lithium phosphate to LiOH·H₂O by electrolysis is performed in a multi-compartment electrolysis unit, wherein the lithium phosphate is dissolved in an acid which then serves as anolyte solution, and LiOH is generated in the catholyte.

21. The method of claim 20 wherein the electrolysis step consumes energy less than 6.0 kwh/kg of produced LiOH·H₂O.
